(19) United States
(12) Patent Application Publication
(10) Pub. No.: US 2022/0015540 A1
(43) Pub. Date: Jan. 20, 2022

(54) MODULAR SUPPORT ASSEMBLY FOR VERTICALLY DISPOSED OBJECTS INCLUDING TELEVISIONS AND VIDEO MONITORS

(71) Applicant: Suncraft Solutions, Inc., POMONA, CA (US)

(72) Inventor: Michael Roach, Libertyville, IL (US)

(21) Appl. No.: 17/375,810

(22) Filed: Jul. 14, 2021

Related U.S. Application Data
(60) Provisional application No. 63/052,078, filed on Jul. 15, 2020.

(51) Int. Cl. A47B 96/02; A47B 97/00; F16M 13/02

(52) U.S. Cl. CPC A47B 96/02; A47B 2097/005; F16M 13/022; A47B 97/00

(57) ABSTRACT

A modular support assembly system includes a first support assembly including a first stand, a first adjustable arm extending from the first stand, and at least one first receiving bracket provided with the first stand; a second support assembly including a second stand, a second adjustable arm extending from the second stand, and at least one second receiving bracket provided with the second stand; and a connector configured to mate with one of the at least one first receiving bracket and one of the at least one second receiving bracket to mate the first support assembly and the second support assembly.

### PRIORITY CLAIM

This application claims priority to and the benefit of U.S. Provisional Application No. 63/052,078, filed Jul. 15, 2020, the entire contents of which are incorporated by reference and relied upon.

### BACKGROUND

The present disclosure relates generally to stands or shelving. More specifically, the present disclosure relates to a stand or shelf for vertically disposed objects, such as televisions and video monitors.

The use of flat screen televisions is ever-increasing. Seemingly all new televisions will eventually be flat screens. Flat screen technology has also become standard for computer monitors. Moreover, flat screen technology has become very pervasive in the workplace, including individual work stations sometimes employing multiple computer monitors, large video monitors for meetings and conference calls, and video conferencing.

Older televisions often had a flat horizontal top surface. The flat top surface was often used to place and house pictures, television remote controls, ornaments and the like. The flat top surface was very convenient because it sat directly above the typical focal point of the room, namely, the television screen. Flat screen televisions and video monitors, by definition, do not have flat horizontal top surfaces. Flat screen televisions and video monitors instead have thin horizontal borders that cover the top of the video screen and associated electronics located behind the screen.

There is accordingly a need for a stand or shelf that provides a flat horizontal surface along the top of a flat screen device, such as, televisions, computer monitors, video monitors and the like. As is known, flat screens can be stand-supported or be wall mounted. There is a need accordingly for a stand or shelf that provides a flat horizontal surface along the top of either a stand-supported or a wall mounted flat screen device. Additionally, because different users desire to place differently sized items on the stand or shelf, there is for the size of the shelf to be variable.

### SUMMARY

The present disclosure provides a modular support assembly system that forms a flat horizontal supporting surface along the top of any flat screen device, such as, televisions, computer monitors, video monitors and the like. The modular support assembly system includes at least two modular support assemblies each having a stand that extends horizontally at the top of the flat screen devices. The user can place one or more object on each of the stands, such as speakers, a soundbar or other electronic device, remote control, pictures, ornaments, books, supply, plants etc.

The underside of each stand includes at least one receiving bracket. For example, a receiving bracket may be provided on each lateral side of the underside of each stand. The receiving brackets are configured to receive one end of a connector, which in one embodiment is provided as a separate piece of the overall modular support assembly system. A receiving bracket of a second stand of a second support assembly receives the other end of the connector, thus linking the two support assemblies to, for example, double the overall lateral length and support ability. The system is accordingly modular. Three or more support assemblies may be linked in a same manner, wherein a middle support assembly has two receiving brackets that each receive one end of a pair of connectors. The other ends of the connectors fit into receiving brackets of adjacent support assemblies. The overall lateral length may therefore, for example, be tripled or quadrupled.

In one embodiment, the receiving brackets are spaced from the edges of the lateral sides, and the connectors are sized such that when the connectors become releasably fitted into the receiving brackets, the edges of the lateral sides of the two mating stands abut each other in a flush manner to avoid forming gaps between the stands. The connectors and stands, including the receiving brackets, may be made (e.g., molded) of a suitable plastic, e.g., polyvinylchloride (“PVC”) polyethylene (“PE”), polyurethane (“PU”), polycarbonate (“PC”) or acrylonitrile butadiene styrene (“ABS”), wherein the at least one receiving bracket is molded with the rest of the stand. The stands may alternatively be made (e.g., formed) of a suitable metal such as stainless steel, steel and/or aluminum, wherein the at least one receiving bracket is fastened or welded to the rest of the stand.

The connectors may likewise be made, e.g., molded, of any of the above plastics or be formed from any of the above metals. The connectors in an embodiment each include a middle member and first and second spring clips extending in opposing directions outwardly from first and second sides of the middle member. The spring clips may each include first and second spring arms that extend outwardly from the middle member and a central tongue that resides between the first and second spring arms. The first and second spring arms are configured and arranged when inserted into a mating receiving bracket to bend inwardly until inserted a certain distance after which the spring arms are released such that the spring arms flex outwardly to their unbiased positions and lock into place against the receiving bracket along a snap-fitting edge of the spring arm. To remove the connector, the user compresses the spring arms inwardly until the arms clear the thickness of the receiving bracket, after which the connector is removed from within the bracket.

The tongue of each spring clip may act as a guide for the connector by sliding between walls of mating the receiving bracket and may also act as a bending stop so that the user does not overly compress the spring arms to the point that the arms break or become permanently deformed. The tongues in one embodiment extend outwardly from the middle member a same or almost the same distance as the spring arms.

The width of the middle member and the spacing of the receiving brackets from the edges of the lateral sides of the stands are provided in an embodiment such that when the connectors become releasably fitted into the receiving brackets, half of the width of the middle member overlies one of the two mating stands, while the other half of the width of the middle member overlies the other of the two mating stands. And again, the fitting of the connector into the brackets is made such that the edges of the lateral sides of the two mating stands abut each other in a flush manner to avoid forming gaps between the stands.

As discussed above, the connectors in one embodiment are provided as separate pieces within the modular support assembly system. In another embodiment, a single spring clip as just described is permanently affixed to or provided with one stand, while a mating stand is provided with a mating receiving bracket. For example, suppose that the modular support assembly system is provided with three support assemblies. The outer support assemblies may be provided as left and right counterparts, each having a permanently affixed or provided spring clip. The middle support assembly is then provided with two receiving brackets. Thus if the user wants to use only one support assembly, the user uses the middle support assembly. If the user wants to use two connected support assemblies, the user uses the middle support assembly and one of the left or right support assembly. If the user wants to use three connected support assemblies, the user uses the middle support assembly and both the left and right support assemblies. In all three scenarios, the permanently affixed or provided spring clips are hidden from view.

It should be appreciated that the connectors may be formed in alternative ways. For example, instead of providing spring clips that extend outwardly from the middle member, the connectors may instead provide tapered tongues that increasingly press-fit into the receiving brackets until the middle members abut against the receiving brackets. Here, mating support assemblies are held together via press-fit. The tapered tongue connectors may likewise be provided as separate pieces within the modular support assembly system or be permanently affixed to or provided with one of the stands.

Other alternative connectors include alternative spring clips. For example, instead of bending inwardly as discussed above, the spring clips may instead bend outwardly and snap-fit around an outside edge of the receiving bracket. The alternative spring clip connectors may likewise be provided as separate pieces within the modular support assembly system or be permanently affixed to or provided with one of the stands.

It is contemplated to further alternatively structure the stands to releasably connect directly to adjacent stands without the use of a connector. For example, the edges of the stands may be configured to slide or press-fit together via a rounded or angled tongue and groove relationship. Or, the edges of the stands may be configured to overlie each other, e.g., wherein one stand includes projections that snap-fit through mating apertures in the other stand.

The support assemblies of the modular system may be provided with one or more of any type of adjustable arm for abutting against the backside of a television, computer monitor or other flat screen device to hold the stand in an at least substantially horizontal position. In one embodiment, the stand includes mounting holes that enable the stand to be connected to one or more mount. The mount is alternatively molded with, welded to or bent from the stand. The mount may include a mounting flange and a ratchet base extending perpendicularly from the mounting flange. The mounting flange if needed may include mounting holes that match the hole pattern formed in the stand. The ratchet base includes, defines, connects to or mates with a ratchet ring.

The support assembly also includes an arm that is placed in ratcheted communication with the ratchet ring affixed to the mount. The arm includes a circular base and a member that extends from the circular base. The circular base includes, defines, connects to or mates with a second ratchet ring. The ratchet ring of the arm is placed in ratchet communication with the ratchet ring of the mount. The circular base includes or defines a hole that allows a torque screw or fastener to fit through the arm and connect to the mount to secure the two ratchet rings together, so that the arm extends at a desired angle relative to the stand. The torque screw can thread into the mount or extend through the mount and thread into a nut or threaded bracket placed on the opposite side of the mount from its ratchet ring.

The user rotates the arm to a desired angle relative to the stand and then tightens the fastener or torque screw so that the two ratchet rings lock together. The desired angle causes the stand of the assembly to sit horizontally on top of the flat screen device (e.g., possibly along with a mated assembly with its arm set at the same angle or a different angle depending on the contour of the back of the flat screen device). A spring is compressed when the ratchet rings lock together to maintain tension on the ratcheted connection. The stand at its front end may include a downwardly bent flange that catches the top front bezel of the flat screen device when the arm contacts the rear of the flat screen device. Rotating the arm to an angle α more away from being straight down (270°) causes the rear end of the stand to sit elevationally higher. Rotating the arm to an angle α closer to being straight down (270°) causes the rear end of the stand to sit at an elevationally lower position. The ratchet rings provide a high degree of adjustability, allowing the user to select an angle α that allows the stand to reside at least substantially horizontally at the top of the flat screen device.

The arm at its distal end includes a cap that abuts against the back of the flat screen device when the support assembly is placed on top of the flat screen device.

The support assembly in one embodiment provides a quick disconnect/reconnect feature in the form of a cammed lever. The cammed lever includes a dual-lobed cammed head and a handle arm extending integrally from, formed with, or attached to the cammed head. The dual lobes of cammed head each define a circular aperture that receives a cylindrical female threaded nut. The threaded nut receives a male threaded stud of the torque or fastener between the lobes of the cammed head. The dual lobes of cammed head each have a larger radius in a locking direction and a smaller radius in a loosening direct. The user turns the handle arm of the cammed lever in a first direction so that the smaller radius faces the elongated arm of the support assembly, loosening the ratchet rings, and allowing the elongated arm to be set to a desired angle α. The user then turns the handle arm of the cammed lever in the opposite direction, so that the larger radius faces the elongated arm of the support assembly, tightening the ratchet rings together, and locking the elongated arm at the desired angle α.

The assembly can employ one, two or more ratcheted arms to provide whatever support is needed. Using two or more ratcheted arms allows for the stand to be elongated to support multiple objects, or a single elongated object, such as a sound bar. The topper is easy to install and adjust. The parts making up the support assembly can be made of any combination of plastic or metal as discussed above, and may additionally or alternatively be made, in whole or in part of rubber or wood. The parts can be machined or molded. For example, the ratchet rings can be molded plastic pieces that abut up against the mount and the arm, respectively.

In light of the disclosure set forth herein, and without limiting the disclosure in any way, in a first aspect of the present disclosure, which may be combined with any other aspect described herein (or portion thereof), a modular support assembly system includes a first support assembly including a first stand, a first adjustable arm extending from the first stand, and at least one first receiving bracket provided with the first stand; a second support assembly including a second stand, a second adjustable arm extending from the second stand, and at least one second receiving bracket provided with the second stand; and a connector configured to mate with one of the at least one first receiving bracket and one of the at least one second receiving bracket to mate the first support assembly and the second support assembly.

In a second aspect of the present disclosure, which may be used with any other aspect described herein (or portion thereof), the connector is a first connector and the second stand includes multiple receiving brackets, and which includes a third support assembly having a third stand, a third adjustable arm extending from the third stand, and at least one third receiving bracket provided with the third stand; and a second connector configured to mate with one of the multiple second receiving brackets and one of the at least one third receiving bracket to mate the third support assembly with the mated first and the second support assemblies.

In a third aspect of the present disclosure, which may be used with any other aspect described herein (or portion thereof), the first, second and third adjustable arms are configured to be set at the same or different angles for operation.

In a fourth aspect of the present disclosure, which may be used with any other aspect described herein (or portion thereof), the first and second connectors are configured and the first, second and third receiving brackets are positioned relative to the first, second and third stands, respectively, such that the second stand is mated flush with the first stand and the third stand is mated flush with the second stand.

In a fifth aspect of the present disclosure, which may be used with any other aspect described herein (or portion thereof), at least one of the at least one first and second receiving brackets is formed integrally with the respective first and second stands.

In a sixth aspect of the present disclosure, which may be used with any other aspect described herein (or portion thereof), at least one of the at least one first and second receiving brackets is attached to the respective first and second stands.

In a seventh aspect of the present disclosure, which may be used with any other aspect described herein (or portion thereof), the connector is configured to releasably mate with one of the at least one first receiving bracket and one of the at least one second receiving bracket to releasably mate the first support assembly and the second support assembly.

In an eighth aspect of the present disclosure, which may be used with any other aspect described herein (or portion thereof), the connector is provided with a plurality of spring arms to releasably mate with one of the at least one first receiving bracket and one of the at least one second receiving bracket.

In a ninth aspect of the present disclosure, which may be used with any other aspect described herein (or portion thereof), the connector is configured to releasably snap-fit with one of the at least one first receiving bracket and one of the at least one second receiving bracket.

In a tenth aspect of the present disclosure, which may be used with any other aspect described herein (or portion thereof), the connector is configured to press-fittingly releasably mate with one of the at least one first receiving bracket and one of the at least one second receiving bracket.

In an eleventh aspect of the present disclosure, which may be used with any other aspect described herein (or portion thereof), the at least one first receiving bracket is provided on an underside of the first stand and the at least one second receiving bracket is provided on an underside of the second stand.

In a twelfth aspect of the present disclosure, which may be used with any other aspect described herein (or portion thereof), a modular support assembly system includes a first support assembly including a first stand, a first adjustable arm extending from the first stand, and at least one first receiving bracket provided with the first stand; and a second support assembly including a second stand, a second adjustable arm extending from the second stand, and at least one connector provided with the second stand, the at least one connector configured to mate with one of the at least one first receiving bracket to mate the first support assembly and the second support assembly.

In a thirteenth aspect of the present disclosure, which may be used with any other aspect described herein (or portion thereof), the at least one connector is formed integrally with the second stand.

In a fourteenth aspect of the present disclosure, which may be used with any other aspect described herein (or portion thereof), the at least one connector is attached to the second stand.

In a fifteenth aspect of the present disclosure, which may be used with any other aspect described herein (or portion thereof), the at least one connector is configured to releasably mate with one of the at least one first receiving bracket.

In a sixteenth aspect of the present disclosure, which may be used with any other aspect described herein (or portion thereof), a modular support assembly system includes a first support assembly including a first stand, a first adjustable arm extending from the first stand, and wherein the first stand incudes at least one first mating feature; and a second support assembly including a second stand, a second adjustable arm extending from the second stand, and wherein the second stand incudes at least one second mating feature for releasably mating with the at least one first mating feature of the first stand.

In a seventeenth aspect of the present disclosure, which may be used with any other aspect described herein (or portion thereof), the first and second mating features form a tongue and groove relationship.

In an eighteenth aspect of the present disclosure, which may be used with any other aspect described herein (or portion thereof), the first and second mating features are located at or along edges of their respective stands.

In a nineteenth aspect of the present disclosure, which may be used with any other aspect described herein (or portion thereof), the first and second mating features are configured to releasably and snap-fittingly overlie each other.

In a twentieth aspect of the present disclosure, which may be used with any other aspect described herein (or portion thereof), any of the features, functionality and alternatives described in connection with any one or more of FIGS. 1A to 12C may be combined with any of the features, functionality and alternatives described in connection with any other of FIGS. 1A to 12C.

In light of the above aspects and the disclosure below, it is therefore an advantage of the present disclosure to provide a modular support assembly system that forms an adjustable length flat horizontal supporting surface along the top of any flat screen device, such as, televisions, computer monitors, video monitors and the like.

It is another advantage of the present disclosure to provide a modular support assembly system that forms an adjustable length flat horizontal surface along the top of a self-supported or wall mounted flat screen device.

It is a further advantage of the present disclosure to provide a modular support assembly system that forms an adjustable length flat horizontal surface along the top of a flat screen device, and which is adjustable without the use of external tools.

It is yet another advantage of the present disclosure to provide a modular support assembly system having a quick disconnect/reconnect feature.

Moreover, it is an advantage of the present disclosure to provide a modular support assembly system that forms an adjustable length flat horizontal surface along the top of a flat screen device, and which is easy to set and install.

Further still, it is an advantage of the present disclosure to provide a modular support assembly system that forms an adjustable length flat horizontal surface along the top of a flat screen device, and which is sturdy and can support a reasonable amount of weight.

Still further, it is an advantage of the present disclosure to provide a modular support assembly system that forms an adjustable length flat horizontal surface along the top of a flat screen device, and which is highly adjustable.

Additional features, technical effects and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1A is a perspective view of one embodiment of the modular support assembly system of the present disclosure illustrating multiple support assemblies unconnected to one another.

FIG. 1B is a perspective view of the modular support assembly system of FIG. 1A, wherein the support assemblies are releasably connected together.

FIG. 2 is a bottom view of two support assemblies of the modular support assembly system of the present disclosure being connected together.

FIG. 3 is an exploded perspective view of one embodiment of a support assembly usable with the modular support assembly system of the present disclosure of the present disclosure.

FIG. 4 is an assembled perspective view of one embodiment of the support assembly of FIG. 3.

FIG. 5 is a side elevation view of one embodiment of the support assembly of FIGS. 3 and 4.

FIG. 6 illustrates various loose parts of the support assembly of FIGS. 3 to 5.

FIG. 7 is a perspective view illustrating one embodiment of the modular support assembly system of the present disclosure being used with a flat screen device.

FIG. 8 is a perspective view illustrating another embodiment of the modular support assembly system of the present disclosure being used with a flat screen device.

FIG. 9 is an exploded perspective view of another embodiment of a support assembly useable with the modular support assembly system of the present disclosure.

FIG. 10 is an assembled perspective view of a further alternative embodiment of a support assembly usable with the modular support assembly system of the present disclosure.

FIG. 11 is an exploded perspective view of yet a further embodiment of a support assembly usable with the modular support assembly system of the present disclosure.

FIGS. 12A to 12C illustrate various implementations of an alternative embodiment in which the edges of the stands of the support assemblies are configured to be connected together directly.

### DETAILED DESCRIPTION

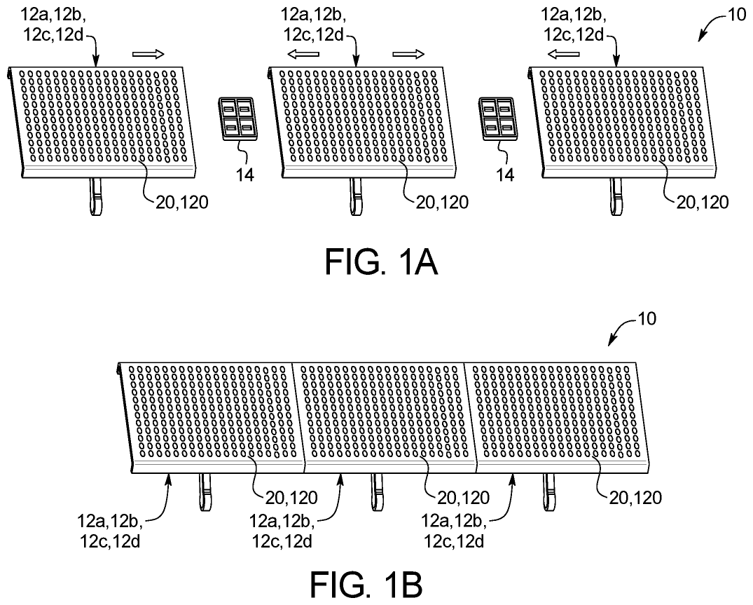

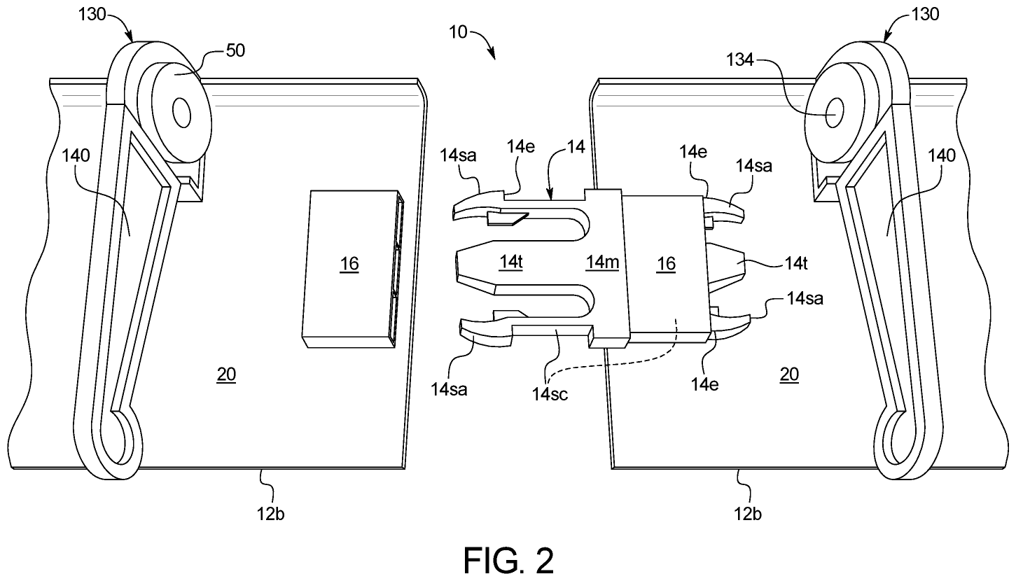

Referring now to the drawings and in particular to FIGS. 1A, 1B and 2, various embodiments of a modular support assembly system 10 of the present disclosure are illustrated. Discussed below are four different support assembly embodiments 12a to 12d useable with system 10. FIGS. 1A and 1B illustrate that any support assembly 12a to 12d may be connected and unconnected according to the modular principles discussed herein. FIG. 2 illustrates support assembly 12b being used, however, the teachings in connection with FIG. 2 are applicable to each support assembly 12a to 12d set forth herein.

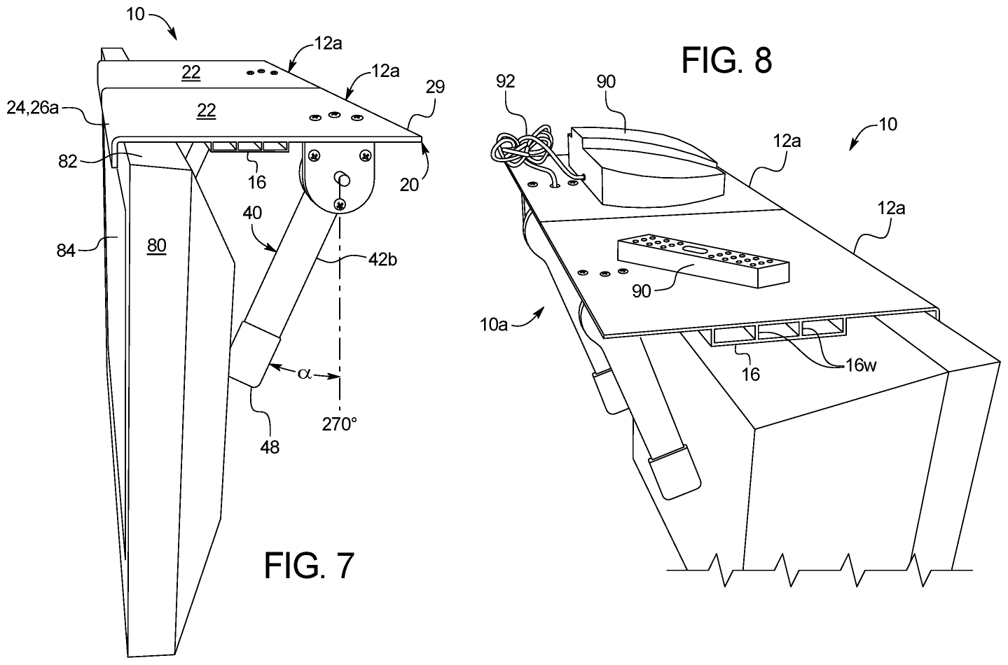

Modular support assembly system 10 forms a flat horizontal supporting surface along the top of any flat screen device, such as, televisions, computer monitors, video monitors and the like (see FIGS. 7 and 8). Modular support assembly system 10 as illustrated in FIGS. 1A and 1B includes at least two modular support assemblies 12a to 12d, each having a stand 20, 120 that extends horizontally at the top of the flat screen devices. The user can place one or more object on each of the stands 20, 120, such as speakers, a soundbar or other electronic device, remote control, pictures, ornaments, books, supply, plants etc.

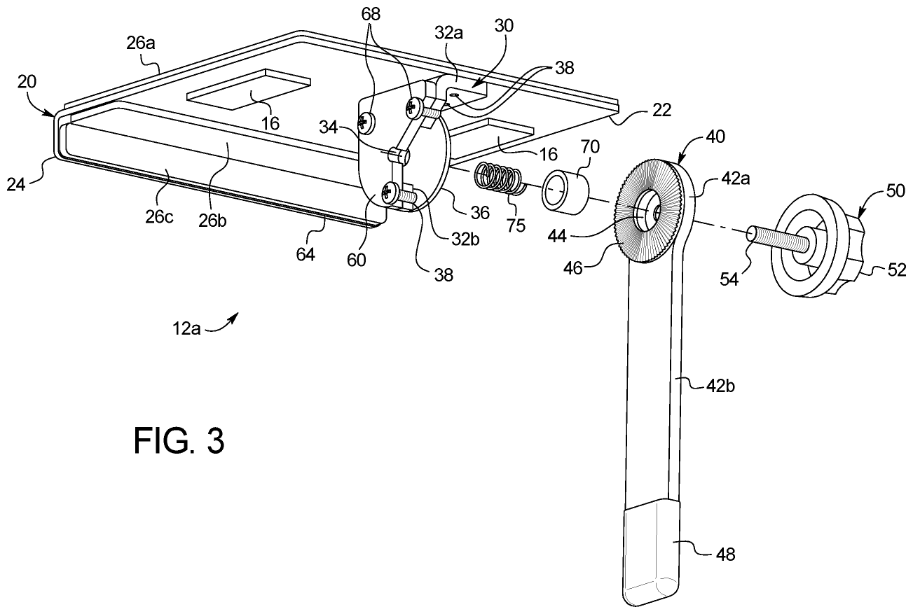

The underside of each stand 20, 120 includes at least one receiving bracket 16 (see also FIGS. 3 to 11). For example, a receiving bracket 16 may be provided on each lateral side of the underside of each stand 20, 120. Receiving brackets 16 are configured to receive one end of a connector 14, which in FIGS. 1A, 1B and 2 is illustrated as being provided as a separate piece of overall modular support assembly system 14. A receiving bracket 16 of a second stand 20, 120 of a second support assembly 12a to 12d receives the other end of connector 14, thus linking the two support assemblies 12a to 12d to, for example, double the overall lateral length and useable support ability. System 10 is accordingly modular. Three or more support assemblies may 12a to 12d may be linked in a same manner, wherein a middle support assembly 12a to 12d has two receiving brackets 16 (see FIGS. 3, 4, 6, 11) that each receive one end of a pair of connectors 14. The other ends of connectors 14 fit into receiving brackets of adjacent support assemblies 12a to 12d. The overall lateral length may therefore, for example, be tripled or quadrupled.

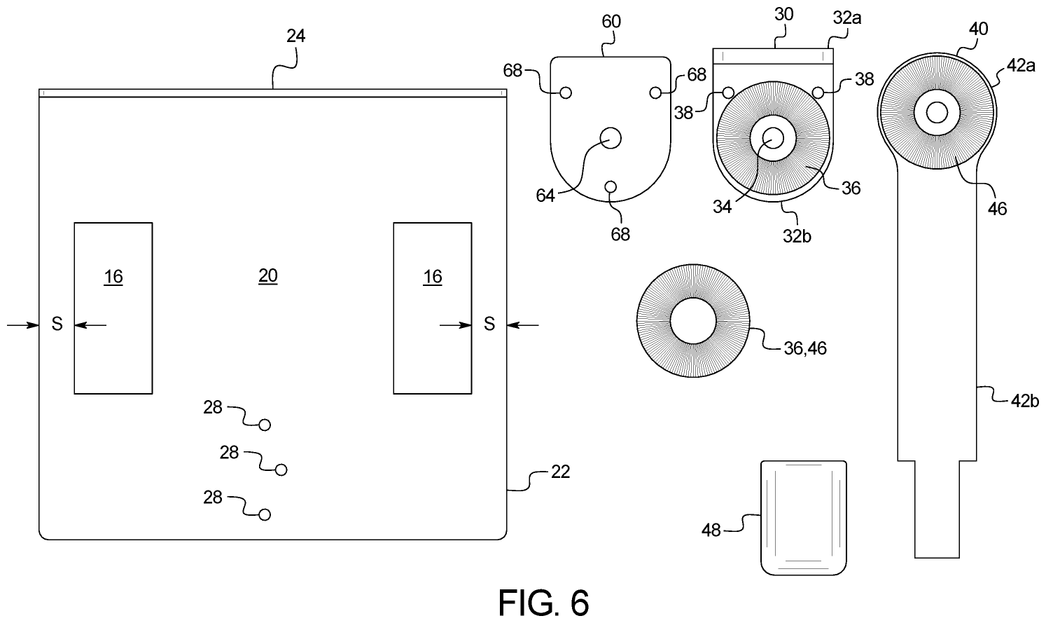

In one embodiment, receiving brackets 16 are spaced from the edges of the lateral sides of stands 20, 120 by a space S (see FIG. 6), while connectors 14 are sized such that when connectors 14 become releasably fitted into receiving brackets 16, the edges of the lateral sides of the two mating stands 20, 120 abut each other in a flush manner to avoid forming gaps between the stands (see FIGS. 1B, 7 and 8). Connectors 14 and stands 20, 120, including receiving brackets 16, may be made (e.g., molded) of a suitable plastic, e.g., polyvinylchloride (“PVC”) polyethylene (“PE”), polyurethane (“PU”), polycarbonate (“PC”) or acrylonitrile butadiene styrene (“ABS”), wherein at least one receiving bracket 16 is molded with the rest of the stand. Stands 20, 120 may alternatively be made (e.g., formed) of a suitable metal such as stainless steel, steel and/or aluminum, wherein at least one receiving bracket 16 is fastened or welded to the rest of the stand.

Connectors 14 may likewise be made, e.g., molded, of any of the above plastics or be formed from any of the above metals. Connectors 14 in the embodiment illustrated in FIG. 2 each include a middle member 14m and first and second spring clips 14sc extending in opposing directions outwardly from first and second sides of middle member 14m. Spring clips 14sc in the illustrated embodiment each include first and second spring arms 14sz that extend outwardly from middle member 14m and a central tongue 14t that resides between first and second spring arms 14sa. First and second spring arms 14sa are configured and arranged when inserted into a mating receiving bracket 16 to bend inwardly until inserted a certain distance after which spring arms 14sa are released such that the spring arms flex outwardly to their unbiased positions and lock into place against receiving bracket 16 along a snap-fitting edge 14e of spring arm 14sa. To remove connector 14 from a receiving bracket 16, the user compresses spring arms 14sa inwardly until the arms clear the wall thickness of receiving bracket 16, after which connector 14 may be removed from within bracket 16.

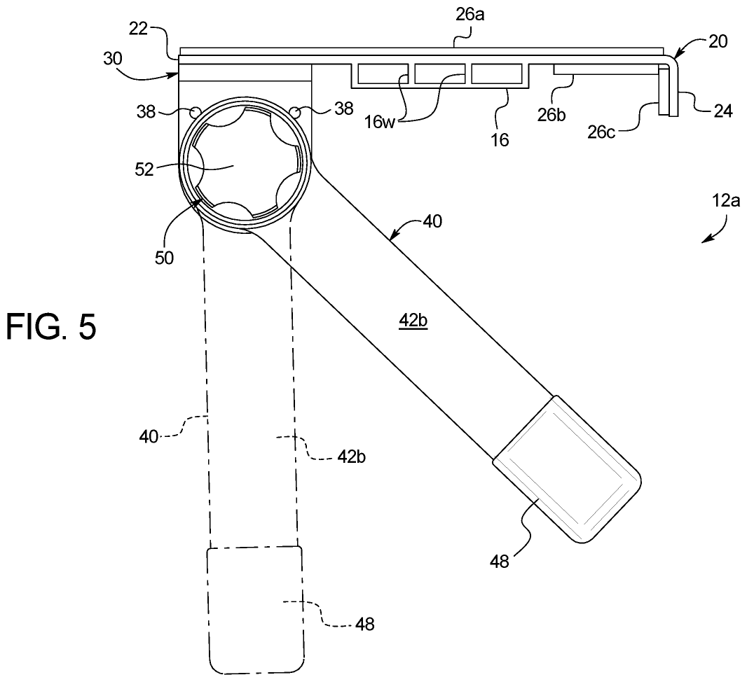

Tongue 14t of each spring clip 14sc may act as a guide for connector 14 by sliding between walls 16w (see FIGS. 5, 9 and 10) of mating a receiving bracket 16 and may also act as a bending stop so that the user does not overly compress spring arms 14sa to the point that the arms break or become permanently deformed. Tongues 14t in the illustrated embodiment of FIG. 2 extend outwardly from middle member 14m a same or almost the same distance as spring arms 14sa.

The width W of middle member 14m (FIG. 2) and the spacing S (FIG. 6) of receiving brackets 16 from the edges of the lateral sides of stands 20, 120 are provided in an embodiment such that when connectors 14 become releasably fitted into receiving brackets 16, half of the width W of middle member 14m overlies one of the two mating stands 20, 120, while the other half of the width W of middle member 14m overlies the other of the two mating stands 20, 120. And again, the fitting of connector 14 into receiving brackets 16 is made such that the edges of the lateral sides of the two mating stands 20, 120 abut each other in a flush manner to avoid forming gaps between the mated stands 20, 120.

As discussed above, connectors 14 in one embodiment are provided as separate pieces within modular support assembly system 10. In another embodiment, a single spring clip 14sc as just described is permanently affixed to or provided with one stand 20, 120, while a mating stand 20, 120 is provided with a mating receiving bracket 16. For example, suppose that modular support assembly system 10 is provided with three support assemblies 12a to 12d. The outer support assemblies 12a to 12d may be provided as left and right counterparts, each having a permanently affixed or provided spring clip 14sc. The middle support assembly is then provided with two receiving brackets 16. Thus if the user wants to use only one support assembly 12a to 12d, the user uses the middle support assembly. If the user wants to use two connected support assemblies 12a to 12d, the user uses the middle support assembly and one of the left or right support assembly. If the user wants to use three connected support assemblies 12a to 12d, the user uses the middle support assembly and both the left and right support assemblies. In all three scenarios, the permanently affixed or provided spring clips 14sc are hidden from view.

It should be appreciated that connectors 14 may be formed in alternative ways. For example, instead of providing spring clips 14sc that extend outwardly from middle member 14m, the connectors may instead provide tapered tongues that increasingly press-fit into receiving brackets 16 until middle members 14m abut against the receiving brackets. Here, mating support assemblies 12a to 12d are held together via press-fit. The alternative tapered tongue connectors may likewise be provided as separate pieces within the modular support assembly system 10 or be permanently affixed to or provided with one of stands 20, 120.

Other alternative connectors include alternative spring clips. For example, instead of bending inwardly as discussed above, the spring clips may instead bend outwardly and snap-fit around an outside edge of receiving bracket 16. The alternative spring clip connectors may likewise be provided as separate pieces within modular support assembly system 10 or be permanently affixed to or provided with one of stands 20, 120.

Referring additionally to FIGS. 3 to 6, one embodiment for a support assembly 12a usable and connectable with modular support assembly system 10 is illustrated. Support assembly 12a in the illustrated embodiment includes a stand 20, a mount 30 connected to stand 20, an arm 40 that is placed in ratcheted communication with mount 30, a fastener or torque screw 50 for selectively tightening and loosening arm 40 to mount 30, and a bracket 60 for threadingly engaging torque screw 50. Each of stand 20, mount 30, arm 40, torque screw 50 and bracket 60 can be made of metal (e.g., steel, stainless steel, aluminum), plastic (e.g., polyvinylchloride (“PVC”) polyethylene (“PE”), polyurethane (“PU”), polycarbonate (“PC”) or acrylonitrile butadiene styrene (“ABS”)), rubber, wood, composite materials, and any combination thereof. Each of FIGS. 3 to 6 illustrates stand 20 having at least one receiving bracket 16 discussed above for receiving at least one connector 14 for modular support assembly connection.

Stand 20 includes a top plate 22 and a front flange 24 extending from or connected to top plate 22. Top plate 22 and front flange 24 can be for example about 0.125 inch (3.2 mm) thick or thicker if desired. Front flange 24 is placed in front of the flat screen device, such as, a television, computer monitor, video monitor, etc. Front flange 24 accordingly does not extend too far downwardly, so as not to block the viewing of the image displayed on the flat screen device. Top plate 22 in one embodiment is six inches (15.2 cm) wide (dimension extending along top of the flat screen device) and 5.5 inches (14.0 cm) deep (dimension extending from back of the flat screen device). Top plate 22 can have different widths and depths, e.g., can have a twelve inch (30.4 cm) double width and two or more ratcheting subassemblies to support the larger width as illustrated below.

Top plate 22 and front flange 24 are metal or plastic in one embodiment and are provided respectively with top surface padding 26a, bottom surface padding 26b and inner flange surface padding 26c. Padding 26a, 26b, and 26c can be a softer metal, plastic, covered foam, covered sponge, rubber, foam rubber, wood, or combinations thereof. In an embodiment padding 26a, 26b and 26c is adhered to, heat sealed to, sprayed onto and/or mechanically attached to the respective mating surfaces of top plate 22 and front flange 24. Padding 26a, 26b, and 26c helps to prevent scratching of the flat screen device. Padding 26a, 26b, and 26c also helps to prevent objects set onto top plate 22 from scratching the top plate, and may also help to prevent the objects from slipping.

FIG. 6 illustrates that stand 20 includes or defines mounting holes 28. The illustrated embodiment shows three holes, wherein the middle hole is offset from the outer mounting holes, which helps to prevent mount 30 from pivoting under load in any direction relative to stand 20. Stand 20 can have alternative numbers and configurations for mounting holes 28, and have additional holes, e.g., for routing electrical cords and wires.

Mount 30 includes a mounting flange 32a and a ratchet base 32b. In one embodiment mounting flange 32a and ratchet base 32b are bent or formed from the same piece of metal or plastic forming mount 30. In another embodiment, mounting flange 32a and ratchet base 32b are separate pieces that are secured together, e.g., via welding, adhesive, and/or via mechanical securement. Mounting flange 32a and ratchet base 32b can be made of a thicker material than for stand 20, e.g., on the order of 0.125 inch (3.2 mm) thick to 0.375 inch (9.5 mm) thick.

Ratchet base 32b includes or defines a center hole 34 for receiving the threaded stud 54 of torque screw 50 or fastener. Center hole 34 can be a through-hole sized to allow the threaded stud 54 of torque screw 50 to pass through. Center hole 34 can alternatively be female threaded to threadingly engage the male threads of the threaded stud 54 of torque screw 50.

Ratchet base 32b also includes, defines or attaches to a circular set of ratchets 36, which engage mating ratchets of arm 40. Individual ratchets 36 have a triangular cross-section in one embodiment and are disposed radially about a center point to form a circle or ring. Ratchets 36 extend outwardly from a base portion of ratchet base 32b in a same direction as the direction in which mounting flange 32a extends from ratchet base 32b of mount 30.

In one embodiment, ratchets 36 or ratchet ring 36 is a separate plastic or metal piece that abuts up against ratchet base 32b of mount 30. For example, separate ratchet ring 36 can be a molded plastic piece made of any of the plastics listed above, or of a tougher plastic, such as Teflon. In another embodiment, ratchets 36 or ratchet ring 36 is formed with ratchet base 32b and mount 30. For example, ratchet ring 36 can be machined from the same piece of metal with ratchet base 32b to form mount 30. Or, ratchet ring 36 can be formed from the same plastic mold as ratchet base 32b to form mount 30. FIG. 6 illustrates ratchet ring 36 both as a separate, stand alone, piece and as formed with ratchet base 32b.

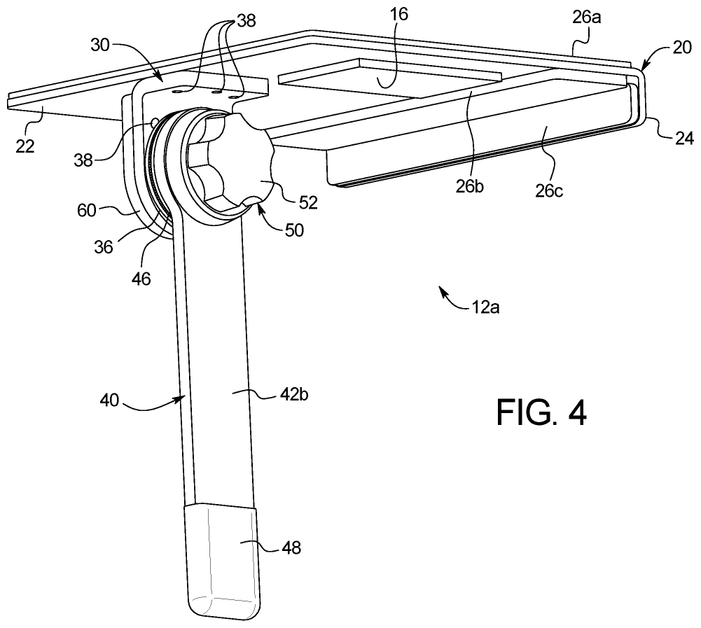

Mounting flange 32a and ratchet base 32b of mount 30 each define mounting holes 38, and in the illustrated embodiment, define three mounting holes 38. The mounting holes 38 of mounting flange 32a (illustrated best in FIGS. 3 and 4) are spaced apart so as to match mounting holes 28 defined in top plate 22 of stand 20. Mounting holes 38 and mounting holes 28 can each be through holes for receiving bolts that are fastened via separate nuts to tighten mount 30 against stand 20. Alternatively, either mounting holes 38 or mounting holes 28 are threaded to threadingly receive bolts or fasteners to tighten mount 30 against stand 20. In an embodiment, mounting holes 38 are threaded, and the holes of padding 26a that made the holes 28 of stand 20 are enlarged to allow bolt heads sit down into the padding, so that the bolt heads do not reside above padding 26a and interrupt the supporting surface of stand 20. In various alternative embodiments, mount 30 can be permanently welded to or formed with stand 20.

The mounting holes 38 of ratchet base 32b of mount 30 can likewise be either through holes or be threaded. FIG. 6 illustrates that the top two mounting holes 38 of ratchet base 32b extend all the way through ratchet base 32b of leg 32b. If ratchet ring 36 is a separate piece, the bottom mounting hole 38 of mount 30 also extends all the way through ratchet base 32b. If ratchet ring 36 is formed as part of or integrally with mount 30, then bottom hole 38 of mount 30 is a blind hole that does not extend through the integrally formed ratchet ring 36 of mount 30.

If center hole 34 of ratchet base 32b of mount 30 is a through hole, then bracket 60 can be provided, wherein the center hole 62 of bracket 60, which aligns with center hole 34 of mount 30, is threaded to threadingly receive the threaded stud 54 of torque screw or fastener 50. Bracket 60 in turn includes mounting holes 68, which align with the mounting holes 38 of ratchet base 32b. Mounting holes 68 of bracket 60 and mounting holes 38 of ratchet base 32b can both be through holes that accept bolts or fasteners, which in turn threadingly engage nuts to fasten bracket 60 to ratchet base 32b of mount 30. Alternatively, either mounting holes 68 or mounting holes 38 are threaded to threadingly engage bolts or fasteners to fasten bracket 60 to ratchet base 32b of mount 30.

If center hole 34 of ratchet base 32b of mount 30 is a threaded hole, then bracket 60 need not be provided, and thus mounting holes 38 of ratchet base 32b need not be provided. Threaded center hole 34 of ratchet base 32b now receives the threaded stud 54 of torque screw 50. In a further alternative embodiment, center hole 34 of ratchet base 32b of mount 30 is a through hole, and a nut is welded to the side of ratchet base 32b opposite to that of ratchets 36. Here again, bracket 60 and mounting holes 38 ratchet base 32b need not be provided. The welded nut instead receives the threaded stud 54 of torque screw 50.

Mount 30 mates with arm 40 as illustrated in FIGS. 3 to 5. Arm includes a circular base 42a and a member 42b extending from base 42a. Circular base 42a includes or defines a hole or aperture 44 that receives the threaded stud 54 of torque screw 50. Fastener or torque screw 50 abuts up against the side of circular base 42a that opposes ratchets or ratchet ring 46.

Just like with ratchets 36 or ratchet ring 36 of mount 30, in one embodiment, ratchets 46 or ratchet ring 46 of arm 40 is a separate plastic or metal piece that abuts up against base 42a of arm 40. For example, separate ratchet ring 46 can be a molded plastic piece made of any of the plastics listed above, or of a tougher plastic, such as Teflon. Separate ratchets 36 and 46 can be the same pieces so that they mate together properly. In another embodiment, ratchets 46 or ratchet ring 46 is formed with base 42a and arm 40. For example, ratchet ring 46 can be machined from the same piece of metal with base 42a to form arm 40. Or, ratchet ring 46 can be formed from the same plastic mold as base 42a to form arm 40. Integrally formed ratchets 36 and 46 can have the same size and number of individual ratchet peaks, so that they mate together properly. FIG. 6 illustrates ratchet ring 46 both as a separate, stand alone piece and as formed with circular base 42b.

Ratchets 36 and 46 provide support assembly 12a with a large amount of adjustability. The user simply turns arm 40 until ratchets 36 and 46 align at an angle, such that top plate 22 is relatively horizontal when the distal end of member 42 abuts the flat screen device.

Member 42b extends from base 42a a distance, such that the total length of arm 40 is longer than the depth of top plate 22 in one embodiment, which is illustrated in FIG. 5. That is, if top plate 22 is 5.5 inches (14.0 cm) deep (dimension extending from the back of the flat screen device), then the total length of arm 40 can be 6 inches (15.2 cm) or longer. The length of member 42b is the total length of arm 40 less the diameter of circular base 42a. FIG. 5 illustrates that member 42b can rotate to virtually any desired angle about hole or aperture 44 and threaded stud 54.

Arm 40, (including member 42b), like mounting flange 32a and ratchet base 32b of mount 30, can be made of a thicker material, e.g., on the order of 0.125 inch (3.2 mm) thick to 0.375 inch (9.5 mm) thick. Member 42b is substantially straight in the illustrated embodiment, but can have a slight taper, such that member 42b narrows as it extends from circular base 42a to its distal end. As illustrated in FIG. 6, the distal end of member 42b can also be reduced in size to accommodate a soft cap 48, such as a rubber (e.g., silicone) or plastic cap (e.g., a softer plastic), so that arm 40 will not scrape or scratch the flat screen device when abutted against the device. Soft cap 48 can be press-fitted, adhered, and/or fastened mechanically to the distal end of member 42b.

Fastener or torque screw 50 incudes a knob or handle 52 connected to or formed with a threaded stud 54 discussed above. Handle 52 and stud 54 can each be any of the metals or plastics discussed herein, or combinations thereof. For example, handle can be polycarbonate, while stud 54 can be steel, stainless steel or aluminum. Handle 52 can be knurled or have finger extensions and undulations, as illustrated in FIGS. 3 to 5. Threaded stud 54 can be of a relatively robust diameter, e.g., 0.25 inch (6.4 mm) to 0.500 inch (12.7 mm) or of a standard metric equivalent thread diameter, e.g., 6 mm, 7 mm, 8 mm, 9 mm, 10 mm, 11 mm, 12 mm or 13 mm. The female thread of hole 34 or 64 is sized to match the male thread diameter and pitch of threaded stud 54.

FIG. 3 illustrates that a collar 70, and a spring 75 located within collar 70, are in turn located within openings 34 and/or 44 of ratchet base 32b of mount 30 and/or base 42a of arm 40, respectively. In an embodiment, collar 70 and spring 75 are located solely within opening 44 in base 42a of arm 40. Collar 70 can be metal or plastic, such as Teflon. Spring 75 is sized so that it (i) holds ratchet rings 36 and 46 apart when fastener or torque screw 50 is loosened, and (ii) provides a lock washer biasing effect when torque screw 50 is tightened so that arm 40 is pressed firm and in a desired angular position against mount 30. Spring 75 is also sized so that it is not too difficult for the user to compress the spring when tightening torque screw 50.

Referring now to FIGS. 7 and 8, examples of multiple support assemblies 12a in modular use within system 10 are illustrated. FIG. 7 illustrates that front flange 24 and support pad 26c are abutted against the top, front horizontal bezel 82 of flat screen device 80, e.g., flat screen television, flat screen computer monitor, flat screen video monitor and the like, while free end or cap 48 of arm 40 engages a rear surface of flat screen device 80. Front flange 24 is sized so as not to extend down over a screen 84 of flat screen device 80. Member 42b of arm 40 is rotated from a straight vertical position (270°) to a desired position or angle α (about 245° in the illustrated example), so that top plate 22 of stand 20 resides at least substantially horizontally relative to flat screen device 80. At the desired angle, the user locks ratchet 46 against ratchet 36, using torque screw or fastener 50. The user can later unscrew fastener 50 to set connected support assemblies 12a at a difference angle for a different device 80, or disassemble support assembly 12a, e.g., for transport.

It should be appreciated that rotating member 42b of arm 40 towards the straight vertical position (270°) would lower the rear end 29 of top plate 22 relative to the top of flat screen device 80 in FIG. 7. Rotating member 42b of arm 40 further away from the straight vertical position (270°) in FIG. 7 would raise the rear end 29 of top plate 22 relative to the top of flat screen device 80. Providing ratchet rings 36 and 46 with many individual ratchets or teeth, e.g., seventy-two ratchets or teeth, allows for a fine adjustment of the rear end 29 of top plate 22, so that top plate 22 can be made at least substantially horizontal regardless of the backside configuration of flat screen device 80. Generally, “flatter” backside configurations for devices 80 will require that rotating member 42b be rotated further away from the straight vertical position (270°), while bulkier backside configurations for devices 80 will require that rotating member 42b be rotated closer to the straight vertical position (270°). In any case, soft cap 48 at the end of arm 40 provides for scratchless contact with flat screen device 80. Soft cap 48 in an embodiment also has a relatively high coefficient of friction, which helps to keep support assembly 12a from slipping against flat screen device 80.

FIG. 8 illustrates objects 90 placed on top plate 22 of stand 20 of both connected support assemblies 12a. In an embodiment, support assemblies 12a (and each of the assemblies 12a to 12d described herein) can support at least twenty lbs. (44 kg). It is expressly contemplated to size top plate 22 so as to support speakers and sound bars, which can be difficult to locate, especially when flat screen device 80 is wall mounted. Also, mounting speakers above a television is advantageous because most of the sound in a television video emanates from the top third of the screen. FIG. 8 illustrates that one of the objects 90 has a cord 92 that fits through one of the mounting holes 28 of top plate 22. Here, one of the mounting holes 28 is not used for fastening to mount 30 and instead accepts and directs cord 92 of object 90. Plate 22 alternatively provides one or more hole or aperture (not illustrated), in addition to mounting holes 28, for accepting a cord 92. Further alternatively, rear end 29 of top plate 22 includes or defines one or more clip (not illustrated) for clipping, holding and routing one or more cord 92 of object.

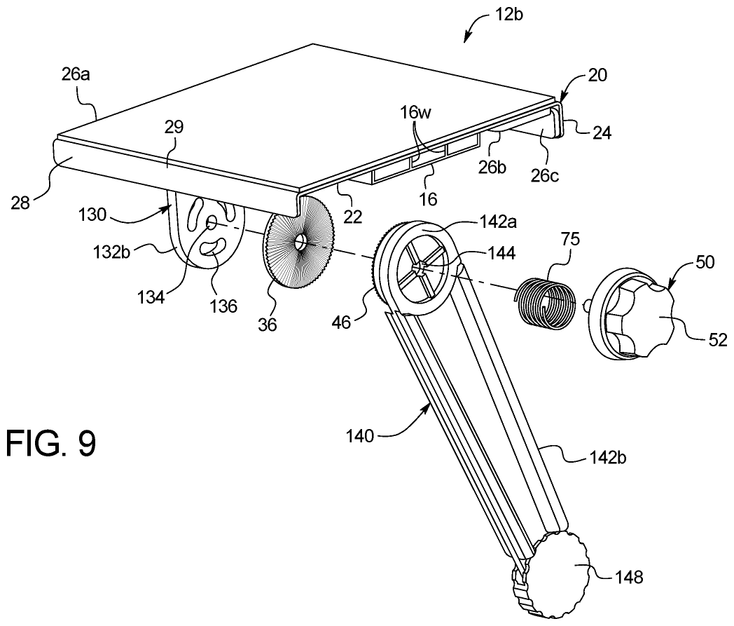

Referring now to FIG. 9, an alternative support assembly 12b usable and connectable with modular system 10 is illustrated. Alternative support assembly 12b includes many of the same features as support assembly 12a, including stand 20, having top plate 22, front flange 24, padding 26a to 26c and all of the materials, structure and alternatives for same discussed above. Stand 20 of support assembly 12b also includes a rear flange 28 located at rear end 29. Rear flange 28 provides additional rigidity to top plate 22 and stand 20. Rear flange 28 can be bent upwardly instead of downwardly as illustrated, so that rear flange 28 also helps to prevent object 90 from sliding off of the rear end of stand 20. Rear flange 28 when bent upwards can also provide notches for holding and routing cords and wires. FIG. 9 illustrates stand 20 having at least one receiving bracket 16 discussed above for receiving at least one connector 14 for modular support assembly connection.

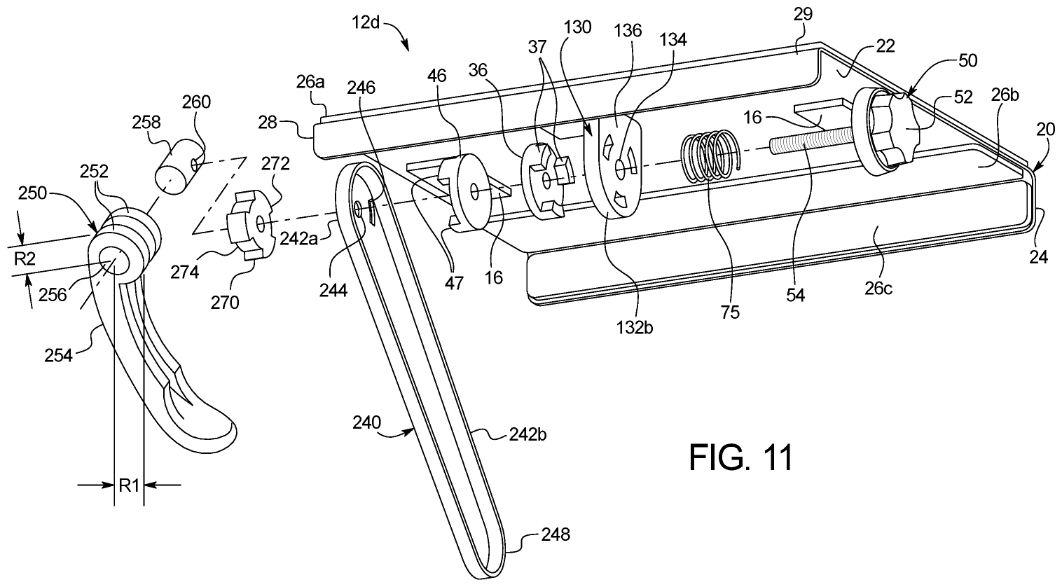

Support assembly 12b also includes an alternative mount 130 and an alternative arm 140. Alternative mount 130 includes mounting flange 132a and ratchet base 132b, and includes all of the materials, structure and alternatives for same discussed above for mount 30. Mounting flange 132a defines mounting holes as is the case with mounting holes 38 of mounting flange 32 of mount 30. Ratchet base 132b defines a threaded hole 134 for receiving torque screw or fastener 50. Threaded bracket 60 (FIG. 3) is accordingly not needed with support assembly 12b. If mount 130 is a molded plastic piece, threaded hole 134 can be a metal insert pressed into ratchet base 132b, so that the threads do not strip. Ratchet base 132b also defines elongated holes or grooves 136 to remove material, weight and cost from support assembly 12b. Elongated holes or grooves 136 in an embodiment also accept like shaped extensions (not seen in FIG. 9 but illustrated below in FIG. 11 as extensions 37) extending from the backside of ratchet ring 36, so that ratchet ring 36 fits into ratchet base 132b and therefore cannot rotated relative to base 132b. Ratchet base 132b is illustrated as operating with a separate ratchet ring 36 but can be formed alternatively with or be permanently attached to ratchet ring 36 as discussed above for ratchet base 32b.

Alternative arm 140 includes a member 142b extending from a circular ratchet base 142a, and includes all of the materials, structure and alternatives for same discussed above for arm 40. Circular base 142a defines a through-hole 144 for accepting threaded stud 54 of torque screw or fastener 50. Spring 75 fits primarily within knob or handle 52 of torque screw 50. Ratchet ring 46 abuts up against the inner surface of circular base 142a and is placed in ratcheted communication with ratchet ring 36 when torque screw 50 is threaded into female threaded hole 134 of mount 130. Ratchet ring 46 can be formed with or be permanently attached to circular base 142a. Ratchet ring 46 is alternatively a separate piece, which can have extensions (not seen in FIG. 9 but illustrated below in FIG. 11 as extensions 47) on the surface opposite its ratcheted surface, that fit into mating grooves or holes (not seen in FIG. 9 but illustrated below in FIG. 11 as grooves or holes 246) formed in circular base 142a, so that separate ratchet ring 46 fits into and cannot rotate relative to circular base 142a of arm 140. Spring 75 acts as a lock washer to hold torque screw 50 tight when ratchet rings 36 and 46 are locked together.

Member 142b in the illustrated embodiment has a slight taper, such that member 42b narrows as it extends from circular base 142a to its distal end. As illustrated in FIG. 9, the distal end of member 142b extends to an integrally formed or molded cap 148, which here is shaped as a knurled wheel. Arm 140 can be any of the plastics discussed above, rubber (e.g., silicone), wood, or a metal having rounded edges, so that arm 140 will not scrape or scratch flat screen device 80 when abutted against the device. Cap 148 can alternatively be a separate piece press-fitted, adhered, and/or fastened mechanically to the distal end of member 142b.

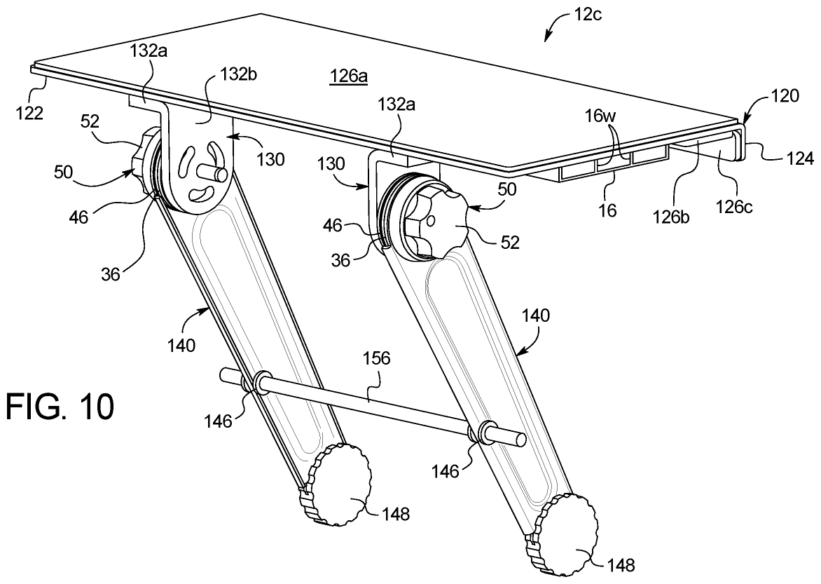

FIGS. 3 to 5 and 7 to 9 illustrate single arm versions of assemblies 12a and 12b, wherein the single arms are at least approximately located side-to-side-wise in the center or middle of stand 20, so that assemblies 12a and 12b are inherently balanced side-to-side-wise. Referring now to FIG. 10, an alternative multi-arm support assembly 12c useable and connectable with modular system 10 is illustrated. Alternative support assembly 12c includes many of the same features as support assembly 12b, including mounts 130, arms 140, torque screws or fastener 50 and springs 75. Mounts 130, arms 140, torque screws 50 and springs 75 can be made of any of the materials, have any of the structure and any of the alternatives discussed above in connection with assemblies 12a and 12b. The primary difference between support assembly 12c and assemblies 12a and 12b is that support assembly 12c includes multiple arms 140 and alternative stand 120 having an elongated top plate 122, flange 124, and padding 126a to 126c. Alternative stand 120 can be made of any of the materials, and have any of the structures and alternatives discussed above for stand 20. Although not illustrated, stand 120 can have a rear flange, such as rear flange 28 of stand 20 of support assembly 12b. FIG. 10 illustrates stand 120 having at least one receiving bracket 16 discussed above for receiving at least one connector 14 for modular support assembly connection.

Elongated stand 120 is supported by two or more arms 140 as illustrated in FIG. 10. Mounts 130 can be alternated as illustrated, so that mounting flanges 132a always point outwards towards the closer of the side edges of stand 120. In one alternative embodiment, a connecting rod 156 is releaseably secured within holes or slots 146 formed in members 142b of arms. Connecting rod 156 allows a user to rotate two or more arms 140 and associated ratchets 46 at one time to a desired angle relative to fixed ratchets 36. Alternatively, connecting rod 156 is not provided and the user instead rotates members 142 individually to the same desired angle α, where ratchet rings 46 can then be tightened against ratchet rings 136. In any case, multiple arms support elongated stand 120, which can be sized for flat screen devices 80 up to eighty-five inches (216 cm) or more. Elongated stand 120 can support multiple objects 90 or an elongated object 90, such as a sound bar.

Referring now to FIG. 11, a further alternative support assembly 12d useable and connectable with modular system 10 is illustrated. Alternative support assembly 12d includes many of the same features as support assembly 12b (and 12a), including stand 20, having top plate 22, front flange 24, padding 26a to 26c and all of the materials, structure and alternatives for same discussed above. Stand 20 of support assembly 12d also includes rear flange 28 located at rear end 29, providing additional rigidity to top plate 22 and stand 20. Rear flange 28 can again be bent upwardly instead of downwardly as illustrated, so that rear flange 28 also helps to prevent object 90 from sliding off of the rear end of stand 20. Rear flange 28 when bent upwards can also provide notches for holding and routing cords and wires. FIG. 11 illustrates stand 20 having at least one receiving bracket 16 discussed above for receiving at least one connector 14 for modular support assembly connection.

Support assembly 12d also includes mount 130 and an alternative arm 240. Mount 130 includes mounting flange 132a (not visible in FIG. 11) and ratchet base 132b, and includes all of the materials, structure and alternatives for same discussed above for mount 30. Mounting flange 132a defines mounting holes as is the case with mounting holes 38 of mounting flange 32 of mount 30. Ratchet base 132b here defines a through hole 134 for allowing threaded stud 54 of torque screw or fastener 50 to pass through ratchet base 132b. Threaded bracket 60 (FIG. 3) is not needed with support assembly 12d. Ratchet base 132b also defines elongated holes or grooves 136 to remove material, weight and cost from support assembly 12b. Elongated holes or grooves 136 in an embodiment also accept like shaped extensions 37 extending from the backside of ratchet ring 36, so that ratchet ring 36 fits into ratchet base 132b and therefore cannot rotated relative to base 132b. Ratchet base 132b is illustrated as operating with a separate ratchet ring 36 but can be formed alternatively with or be permanently attached to ratchet ring 36 as discussed above for ratchet base 32b.

Alternative arm 240 includes a member 242b extending from a circular ratchet base 242a, and includes all of the materials, structure and alternatives for same discussed above for arms 40 and 140. Circular base 242a defines a through-hole 244 for accepting threaded stud 54 of torque screw or fastener 50. Spring 75 again fits primarily within knob or handle 52 of torque screw 50. Ratchet ring 46 abuts up against the inner surface of circular base 242a and is placed in ratcheted communication with ratchet ring 36 when torque screw 50 is threaded into a cammed lever 250 discussed in more detail below. Ratchet ring 46 can be formed with or be permanently attached to circular base 242a. Ratchet ring 46 is alternatively a separate piece, which can have extensions 47 on the surface opposite its ratcheted surface, that fit into mating grooves or holes 246 formed in circular base 242a, so that separate ratchet ring 46 fits into and cannot rotate relative to circular base 242a of arm 240. Spring 75 again acts as a lock washer to hold torque screw 50 and cammed lever 250 tight together, while ratchet rings 36 and 46 are locked together.

Member 242b can again have a slight taper, such that member 242b narrows as it extends from circular base 242a to its distal end. As illustrated in FIG. 11, the distal end of member 242b extends to an integrally formed or molded cap 248. Member 242b and cap 248 as illustrated have or include 90° bent or formed flanges, increasing rigidity. Arm 240 can be any of the plastics discussed above, rubber (e.g., silicone), wood, or a metal having bent or formed flanges, and be smooth so that arm 240 will not scrape or scratch flat screen device 80 when abutted against the device. Cap 248 can alternatively be a separate, soft piece press-fitted, adhered, and/or fastened mechanically to the distal end of member 242b to further reduce scratching.

The primary difference with support assembly 12d of FIG. 11 is the addition of cammed lever 250. Cammed lever 250, including any of its components, can be made of any of the plastics discussed above, rubber (e.g., silicone), wood, or any of the metals discussed above, such as steel, stainless steel or aluminum. Lever 250 includes a dual-lobed cammed head 252 and a handle arm 254 extending integrally from, formed with, or attached to cammed head 252. The dual lobes of cammed head 252 each define a circular aperture 256. Circular apertures 256 of the dual lobes of cammed head 252 are aligned with each other.

The dual lobes of head 252 are cammed such that radius R1 illustrated in FIG. 11 is greater than radius R2. For example, radius R1 can be 5% to 50% greater than radius R2. Cammed lever 250 includes a cylindrical nut 258 that fits within circular apertures 256 defined by the dual lobes of head 252. Cylindrical nut 258 defines a female threaded hole 260 that threadingly receives threaded stud 54 of torque screw or fastener 50. Threaded hole 260 is placed in the longitudinal center of cylindrical nut 258, so that threaded hole 260 resides between the dual lobes of head 252 when cylindrical nut 258 is fully fitted into circular apertures 256 defined by the dual lobes of head 252. In this manner, threaded stud 54 can reach threaded hole 260 while cylindrical nut 258 is fully fitted into the dual lobes of head 252.

A collar 270 is fitted between arm 240 and head 252 of cammed lever 250. Collar 270 can be made of any material discussed herein, e.g., any of the plastics discussed above, rubber (e.g., silicone), wood, or any of the metals discussed above, such as steel, stainless steel or aluminum. Collar 270 defines a through hole 272 through which threaded stud 54 of torque screw or fastener 50 extends to reach threaded hole 260 of cylindrical nut 258. Collar 270 defines plural notches 274 on its side abutting arm 240, which receive extensions 47 of ratchet ring 46 that extend through mating grooves or holes 246 formed in circular base 242a, so that collar 270 cannot rotate when torque screw or fastener 50 is threaded into threaded hole 260 of cylindrical nut 258 of cammed lever 250.

Collar 270 on its side opposite that of notches 274 defines a curved or rounded surface 276 that matingly receives the dual lobes of head 252. When handle arm 254 of cammed lever 250 is pointing at least substantially vertically downwardly as illustrated in FIG. 11, cammed lever 250 is in its locked or tightened position. In the tightened or locked position of FIG. 11, larger radius R1 is abutted against curved or rounded surface 276. The larger radius R1 pulls threaded hole 260 of cylindrical nut 258 away from collar 70, arm 240, ratchet rings 36 and 46, and mount 130, pulling handle 52 of torque screw or fastener 50 firmly against mount 130, and locking ratchet rings 36 and 46 together.

When the user turns handle arm 254 ninety degrees clockwise in FIG. 11, the dual lobes of head 252 transition from the first, larger radius R1 to instead the second, smaller radius R2 being abutted against curved or rounded surface 276. Smaller radius R2 pushes threaded hole 260 of cylindrical nut 258 towards collar 70, arm 240, ratchet rings 36 and 46, and mount 130, overcoming spring 75 and pushing handle 52 of torque screw or fastener 50 away from mount 130, so that ratchet rings 36 and 46 can be separated, allowing the user to rotate ratchet ring 46 and thus arm 240 relative to mount 130 and stand 20. Cammed lever 250 in this manner provides support assembly 12d with a quick disconnect/reconnect mechanism, which provides the user with mechanical advantage via handle arm 254 to quickly, via a ninety degree turn, loosen ratchet rings 36 and 46, reset ratchet ring 46 and arm 240 to a new, desired position, and to quickly, via a reverse ninety degree turn, tighten ratchet rings 36 and 46 together, locking arm 240 in the desired position.

The user can alternatively or additionally loosen and tighten ratchet rings 36 and 46 via torque screw or fastener 50 of support assembly 12d as has been described herein. Alternatively, cammed lever 250 in essence replaces torque screw or fastener 50. Instead, a bolt or threaded rod with a nut, such as a lock nut, is inserted through aperture 134 of ratchet base 132b of mount 130 (or aperture 34 of ratchet base 32b of mount 30). The bolt or threaded rod extends further through ratchet rings 36 and 46 and arm 40, 140, 240 and into cylindrical nut 258, where the bolt or threaded rod mates threadingly with threaded hole 260 of nut 258. Here, spring 75 may also be omitted. In any of the cammed lever 250 embodiments, collar 270 may be omitted. That is, the cammed dual lobes of head 252 can instead abut directly up against elongated arm 40, 140, 240 or against a flat washer located between the cammed dual lobes of head 252 and arm 40, 140, 240.

It should be understood that while flat screen devices are one primary use for support assemblies 12a to 12d, the support assemblies of modular system 10 described herein can be used instead with any relatively thin and flat vertical structure. For example, it is expressly contemplated to use modular support assemblies 12a to 12d in the workplace with cubicle walls. In many instances, cubicle space is at a premium. Support assemblies 12a to 12d provide the worker with additional room for books, pictures, plants, supplies, etc.

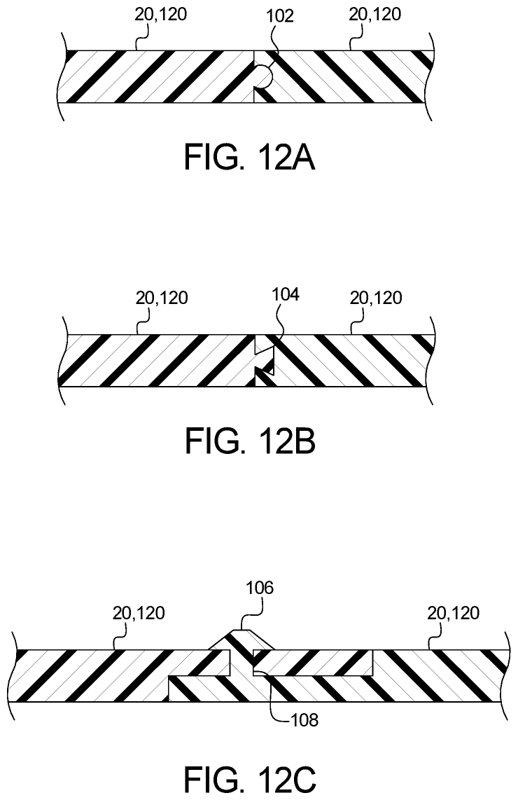

FIGS. 12A to 12C illustrate that it is contemplated to further alternatively structure stands 20, 120 of support assemblies 12a to 12d to releasably connect directly to adjacent stands 20, 120 without the use of a connector. For example, the edges of stands 20, 120 may be configured to slide or press-fit together via a rounded or angled tongue and groove relationship. Or, the edges of stands 20, 120 may be configured to overlie each other, e.g., wherein one stand includes projections that releasably snap-fit through mating apertures in the other stand.

In various examples, FIG. 12A illustrates the edges of two mating stands 20, 120 fitting together via a rounded tongue and groove arrangement 102. Rounded tongue and groove arrangement 102 may be releasably formed via sliding the edges of stands 20, 120 against one another or pressing the edges of stands 20, 120 together. FIG. 12B illustrates the edges of two mating stands 20, 120 fitting together via an angled tongue and groove arrangement 104. Angled tongue and groove arrangement 104 may again be releasably formed via sliding the edges of stands 20, 120 against one another or pressing the edges of stands 20, 120 together. FIG. 12C illustrates that the edges of mating stands 20, 120 are configured to overlie each other in such a way that projection 106 or projections 106 of one of the stands 20, 120 releasably snap-fit through mating apertures 108 of the other stand 20, 120.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims. For example, any of the stands 20, 120 of any of support assemblies 12a to 12d may include on their undersides at least one internal receiving bracket 16 for holding a connector 14 out of sight when not needed for modularity. Here, connectors 14 may be easily stored to prevent them from becoming lost.

The invention is claimed as follows:

1. A modular support assembly system comprising:
a first support assembly including a first stand, a first adjustable arm extending from the first stand, and at least one first receiving bracket provided with the first stand;
a second support assembly including a second stand, a second adjustable arm extending from the second stand, and at least one second receiving bracket provided with the second stand; and
a connector configured to mate with one of the at least one first receiving bracket and one of the at least one second receiving bracket to mate the first support assembly and the second support assembly.

2. The modular support assembly of FIG. 1, wherein the connector is a first connector and the second stand includes multiple receiving brackets, and which includes a third support assembly having a third stand, a third adjustable arm extending from the third stand, and at least one third receiving bracket provided with the third stand; and
a second connector configured to mate with one of the multiple second receiving brackets and one of the at least one third receiving bracket to mate the third support assembly with the mated first and the second support assemblies.

3. The modular support assembly of FIG. 2, wherein the first, second and third adjustable arms are configured to be set at the same or different angles for operation.

4. The modular support assembly of FIG. 2, wherein the first, second and third receiving brackets are positioned relative to the first, second and third stands, respectively, such that the second stand is mated flush with the first stand and the third stand is mated flush with the second stand.

5. The modular support assembly of FIG. 1, wherein at least one of the at least one first and second receiving brackets is formed integrally with the respective first and second stands.

6. The modular support assembly of FIG. 1, wherein at least one of the at least one first and second receiving brackets is attached to the respective first and second stands.

7. The modular support assembly of FIG. 1, wherein the connector is configured to releasably mate with one of the at least one first receiving bracket and one of the at least one second receiving bracket to releasably mate the first support assembly and the second support assembly.

8. The modular support assembly of FIG. 7, wherein the connector is provided with a plurality of spring arms to releasably mate with one of the at least one first receiving bracket and one of the at least one second receiving bracket.

9. The modular support assembly of FIG. 7, wherein the connector is configured to releasably snap-fit with one of the at least one first receiving bracket and one of the at least one second receiving bracket.

10. The modular support assembly of FIG. 7, wherein the connector is configured to press-fittingly releasably mate with one of the at least one first receiving bracket and one of the at least one second receiving bracket.

11. The modular support assembly of FIG. 1, wherein the at least one first receiving bracket is provided on an underside of the first stand and the at least one second receiving bracket is provided on an underside of the second stand.

12. A modular support assembly system comprising:
a first support assembly including a first stand, a first adjustable arm extending from the first stand, and at least one first receiving bracket provided with the first stand; and
a second support assembly including a second stand, a second adjustable arm extending from the second stand, and at least one connector provided with the second stand, the at least one connector configured to mate with one of the at least one first receiving bracket to mate the first support assembly and the second support assembly.

13. The modular support assembly of FIG. 12, wherein the at least one connector is formed integrally with the second stand.

14. The modular support assembly of FIG. 12, wherein the at least one connector is attached to the second stand.

15. The modular support assembly of FIG. 12, wherein the at least one connector is configured to releasably mate with one of the at least one first receiving bracket.

16. A modular support assembly system comprising:
a first support assembly including a first stand, a first adjustable arm extending from the first stand, and wherein the first stand incudes at least one first mating feature; and
a second support assembly including a second stand, a second adjustable arm extending from the second stand, and wherein the second stand incudes at least one second mating feature for releasably mating with the at least one first mating feature of the first stand.

17. The modular support system of claim 16, wherein the first and second mating features form a tongue and groove relationship.

18. The modular support system of claim 16, wherein the first and second mating features are located at or along edges of their respective stands.

19. The modular support system of claim 16, wherein the first and second mating features are configured to releasably and snap-fittingly overlie each other.
